(19) United States
(12) Patent Application Publication
(10) Pub. No.: US 2024/0053279 A1
(43) Pub. Date: Feb. 15, 2024

(54) OVERALL HUMIDTY ANALYSIS SYSTEM FOR CARTON

(71) Applicant: Ningbo Huina Machinery Co., Ltd, (US)

(72) Inventor: Chaoqi XIE, HUNAN (CN)

(21) Appl. No.: 17/766,663

(22) PCT Filed: Aug. 18, 2020
(86) PCT No.: PCT/CN2020/109752

§ 371 Date: Apr. 5, 2022

(30) Foreign Application Priority Data
Jul. 8, 2020 (CN) 202010653613.0

(51) Int. Cl. G01N 21/90; G06T 7/11; G06Q 30/02

(52) U.S. Cl. CPC G01N 21/90; G06T 7/11; G06Q 30/0278; G06T 2207/10024

(57) ABSTRACT

An overall humidity analysis system for a carton, comprising: a threshold determination mechanism used for sending a low-price acquisition instruction when the received overall humidity of the carton is between a first humidity threshold and a second humidity threshold, and used for sending a high-price acquisition instruction when the overall humidity of the carton is below the second humidity threshold, the first humidity threshold being greater than the second humidity threshold; the threshold determination mechanism also used for sending an acquisition prohibition instruction when the overall humidity of the carton is above the first humidity threshold; and a full-color capturing mechanism located on a user handheld terminal and used for performing an image capturing operation on an environment where a plurality of cartons to be acquired are located, so as to obtain a corresponding full-color environment image.

### TECHNICAL FIELD

The invention relates to the field of carton repurchase, and in particular, to an overall humidity analysis system for a carton.

### BACKGROUND

A carton (English name is carton or hard paper case) is the most widely used packaging product. According to different materials, there are corrugated cartons, single layer cartons, and the like with various specifications and models.

The commonly used carton has three layers or five layers. The carton having seven layers is not commonly used. The layers include lining paper, corrugated paper, core paper, and surface paper. The lining paper and the surface paper include a grey board or kraft paper. The core paper includes the corrugated paper. The colors and hand feeling of the various paper are different, and the paper (colors or hand feeling) manufactured by different manufacturers is also different.

The carton is generally used as a wrapper of commodities or an article for protecting an outer layer of an item. A volume of the carton varies with the size of the commodities. Usually, there are various patterns or text prompts on the carton, such as “Handle with Care”, “Keep dry”, “Upward”, “Stacking limit”, “Beware of sunshine”, “Moistureproof”, “Quality safety”, “Do not roll”, “Do not trample”, “Fireproof”, “Fragile”, “Environment-friendly”, “Keep cool”, “Food”, “Odor prevention”, and the like, to remind a user to pay attention, thereby protecting packaged contents from being damaged.

As an indispensable part of modern logistics, packaging cartons bear the responsibility for containing, product protection, and aesthetics. The physical performance indexes of the packaging cartons become a basis for the quality assessment. A stable working environment ensures the accuracy and reliability of test data, and senior engineers who have been engaged in carton testing for many years test and analyze the packaging cartons to provide fair and scientific test data for packaging carton suppliers and packaging carton users. Test technological service (TTS) also provides engineering such as supplier material screening and tender evaluation for many well-known enterprises.

As an important material that can be repurchased, the acquisition price of cartons often raises attention. In an aspect, the concern is the fluctuation of the acquisition price of the cartons. In another aspect, the concern is that some carton sellers are accustomed to spraying water to the cartons for greater economic benefits. In the prior art, there is a lack of relevant mechanism for performing targeted detection on the cartons in the water spray state.

### SUMMARY

The invention has at least the following key inventive points:
(1) On-site detection is performed on the overall humidity of a to-be-acquired carton, to determine a pricing strategy of a current carton according to a distribution range of the overall humidity of the carton.
(2) Specifically, different pricing strategies corresponding to high-price acquisition, low-price acquisition, and acquisition prohibition are adopted for the carton according to three different distribution ranges of the overall humidity of the carton.

An aspect of the invention provides an overall humidity analysis system for a carton. The system includes:
a threshold determination mechanism, connected to a range identification device and configured to: send a low-price acquisition instruction when a received overall humidity of the carton is between a first humidity threshold and a second humidity threshold, send a high-price acquisition instruction when the overall humidity of the carton is below the second humidity threshold, the first humidity threshold being greater than the second humidity threshold, and
send an acquisition prohibition instruction when the overall humidity of the carton is above the first humidity threshold; and
a full-color capturing mechanism, located on a user handheld terminal and configured to perform an image capturing operation on an environment where a plurality of to-be-acquired cartons are located, so as to obtain a corresponding full-color environment image;
a gradient filter, connected to the full-color capturing mechanism and configured to perform gradient sharpening and filtering on the received full-color environment image to obtain and output a corresponding filtered gradient image;
an on-site processing device, connected to the gradient filter and configured to perform histogram equalization on the received filtered gradient image to obtain and output a corresponding equalized image;
a signal enhancement device, connected to the on-site processing device and configured to perform image enhancement on the received equalized image by means of singular value decomposition (SVD), to obtain and output a corresponding signal-enhanced image;
a content storage mechanism, configured to store grayscale distribution ranges of pixel points of imaging regions of cartons having different humidities, the carton having a different humidity leading to a different grayscale distribution range of the pixel points of the imaging region of the carton;
a numerical analysis mechanism, connected to the signal enhancement device and the content storage mechanism and configured to: identify and partition a carton distribution region in the signal-enhanced image to obtain a carton sub-image, acquire grayscale values of pixel points in the carton sub-image, and acquire a median of the grayscale values to obtain a corresponding grayscale median; and
a range identification device, connected to the numerical analysis mechanism and the content storage mechanism and configured to determine, based on a grayscale distribution range in which the grayscale median falls, a humidity corresponding to the grayscale distribution range and output the humidity as an overall humidity of the carton.

The overall humidity analysis system for a carton is convenient to operate and proper in structure. Since a relevant mechanism for performing targeted detection on a water spraying state of the carton can be established, large economic losses of a purchaser of the carton are avoided.

### DETAILED DESCRIPTION

The implementations of the overall humidity analysis system for a carton of the invention are to be described in detail below.

A special-shaped corrugated carton has the most varied packaging varieties in corrugated carton packaging nowadays. Goods in a supermarket are directly placed on shelves, and a good product display function is needed. A problem is how to open the carton package quickly and simply to quickly pick up and place goods without any tools such as scissors or knives, but just shout “Open Sesame”. This sounds fresh, but such cartons have been widely used in supermarkets.

The open-sesame carton has corrugated carton packaging with a new design concept, that is, a corrugated carton that is easily opened. There is no obvious difference between an exterior structure of the carton and that of an ordinary corrugated carton. A key process of the carton is to paste a tear-off adhesive tape inside the corrugated carton and leave a small opening outside the carton. When the carton is required to be opened, the carton can be opened along the tear-off adhesive tape from the small opening without using any tools. In this way, the packaged goods are shown.

In the prior art, during the carton repurchase, due to the lack of a relevant mechanism for performing targeted detection on the carton in a water spray state, a purchaser of the carton often suffers large economic losses.

In order to overcome the above defects, the invention establishes an overall humidity analysis system for a carton, to effectively solve the corresponding technical problems.

An overall humidity analysis system for a carton shown according to an implementation of the invention includes:
a threshold determination mechanism, connected to a range identification device and configured to: send a low-price acquisition instruction when a received overall humidity of the carton is between a first humidity threshold and a second humidity threshold, send a high-price acquisition instruction when the overall humidity of the carton is below the second humidity threshold, the first humidity threshold being greater than the second humidity threshold, and send an acquisition prohibition instruction when the overall humidity of the carton is above the first humidity threshold; and
a full-color capturing mechanism, located on a user handheld terminal and configured to perform an image capturing operation on an environment where a plurality of to-be-acquired cartons are located, so as to obtain a corresponding full-color environment image;
a gradient filter, connected to the full-color capturing mechanism and configured to perform gradient sharpening and filtering on the received full-color environment image to obtain and output a corresponding filtered gradient image;
an on-site processing device, connected to the gradient filter and configured to perform histogram equalization on the received filtered gradient image to obtain and output a corresponding equalized image;
a signal enhancement device, connected to the on-site processing device and configured to perform image enhancement on the received equalized image by means of singular value decomposition (SVD), to obtain and output a corresponding signal-enhanced image;
a content storage mechanism, configured to store grayscale distribution ranges of pixel points of imaging regions of cartons having different humidities, the carton having a different humidity leading to a different grayscale distribution range of the pixel points of the imaging region of the carton;
a numerical analysis mechanism, connected to the signal enhancement device and the content storage mechanism and configured to: identify and partition a carton distribution region in the signal-enhanced image to obtain a carton sub-image, acquire grayscale values of pixel points in the carton sub-image, and acquire a median of the grayscale values to obtain a corresponding grayscale median; and
a range identification device, connected to the numerical analysis mechanism and the content storage mechanism and configured to determine, based on a grayscale distribution range in which the grayscale median falls, a humidity corresponding to the grayscale distribution range and output the humidity as an overall humidity of the carton.

Then, a specific structure of the overall humidity analysis system for a carton of the invention is further described.

In the overall humidity analysis system for a carton:

in the content storage mechanism, a higher humidity of the carton leads to a smaller value of the grayscale distribution range of the pixel points of the imaging region.

In the overall humidity analysis system for a carton:

in the content storage mechanism, the grayscale distribution ranges of the pixel points of the imaging regions of the cartons having the different humidities are all defined by an upper grayscale threshold and a lower grayscale threshold.

In the overall humidity analysis system for a carton:
the upper grayscale threshold is greater than the lower grayscale threshold, and values of the upper grayscale threshold and the lower grayscale threshold both range from 0 to 255; and
the numerical analysis mechanism, the signal enhancement device, and the content storage mechanism share one parallel configuration interface.

The overall humidity analysis system for a carton further includes:
a display device, connected to the numerical analysis mechanism and the range identification device, where
the display device is configured to display various working parameters of the numerical analysis mechanism and various working parameters of the range identification device.

In the overall humidity analysis system for a carton:

the display device is a liquid crystal display or a light-emitting diode (LED) display.

The overall humidity analysis system for a carton further includes:
a touch screen, configured to receive input information of a user according to an operation of the user, where
the display device, the numerical analysis mechanism, the range identification device, and the touch screen are integrated on an integrated circuit board.

The overall humidity analysis system for a carton further includes:
a video communication device, configured to wirelessly send an on-site image obtained by performing image capture on an environment where the numerical analysis mechanism is located.

In the overall humidity analysis system for a carton:
the video communication device includes a compression encoder configured to perform MPEG-4 standard compression on the on-site image to obtain a compressed image; and
the video communication device further includes a multi-index encoder connected to the compression encoder and configured to perform multi-index coding on the compressed image to obtain channel coded data.

In the overall humidity analysis system for a carton:
the video communication device includes a wireless communication interface connected to the multi-index encoder and configured to wirelessly send the channel coded data, where
the wireless communication interface is a time division duplex (TDD) communication interface, a frequency division duplex (FDD) communication interface, a 4G communication interface, or a GPRS communication interface.

In addition, the FDD means that transmission of an uplink and a downlink is performed at different frequencies. In the first generation cellular system and the second generation cellular system, duplex transmission is basically implemented by using the FDD technology. Especially in the first generation cellular system, since continuous baseband signals are transmitted, different frequencies are required to be used to provide duplex uplink and downlink channels. When the FDD technology is used to transmit continuous information in the first generation cellular system, a receiving end and a transmission end are required to be provided with frequency synthesizers generating different carrier frequencies. The receiving end is also required to be provided with a duplex filter that prevents a transmitted signal from leaking to a receiver. In addition, for ease of the manufacturing of a duplexer, a specific frequency interval is required between receiving and transmitting carrier frequencies. The FDD technology is also adopted in the second generation system such as GSM, IS-136, IS-95, or the like. In these systems, since the information is transmitted in a time slot manner, and the receiving and transmitting may be performed in different time slots, the transmitted signal of a mobile station or a base station does not interfere with the current receiver. Therefore, although the FDD technology is adopted, an expensive duplex filter is not required.

The characteristic of an FDD mode is that the system performs receiving and transmission on two separate symmetrical frequency channels (a frequency interval between the uplink and the downlink is 190 MHz), and uses a guard band to separate receiving channels from transmission channels.

The technologies such as packet switching can be used to break through the bottleneck of second generation development, to achieve high-speed data services and improve spectrum utilization, thereby increasing the system capacity. However, the FDD is required to use paired frequencies, that is, the third generation service is provided within a bandwidth of every 2×5 MHz. In this way, spectra of the uplink and the downlink can be fully utilized during support of a symmetric service. However, when asymmetric packet switching (Internet) is used in work, the spectrum utilization is greatly reduced (due to the low uplink load, the spectrum utilization is reduced by about 40%). At this point, the TDD mode has the incomparable advantage over the FDD.

It is to be understood that though the above preferred embodiments are disclosed in the invention, the foregoing embodiments are not to limit the invention. Any one skilled in the art can use the technical contents disclosed above to make various possible variations and modifications to the technical solutions of the invention or make equivalent changes to obtain equivalent embodiments without departing from the scope of the technical solutions of the invention. Therefore, any simple changes, equivalent variations, and modifications made to the above embodiments according to the technical essence of the invention without departing from the contents of the technical solutions of the invention shall fall within the scope of the technical solutions of the invention.

What is claimed is:

1. An overall humidity analysis system for a carton, comprising:
a threshold determination mechanism, connected to a range identification device and configured to: send a low-price acquisition instruction when a received overall humidity of the carton is between a first humidity threshold and a second humidity threshold, send a high-price acquisition instruction when the overall humidity of the carton is below the second humidity threshold, the first humidity threshold being greater than the second humidity threshold, and
send an acquisition prohibition instruction when the overall humidity of the carton is above the first humidity threshold; and
a full-color capturing mechanism, located on a user handheld terminal and configured to perform an image capturing operation on an environment where a plurality of to-be-acquired cartons are located, so as to obtain a corresponding full-color environment image;
a gradient filter, connected to the full-color capturing mechanism and configured to perform gradient sharpening and filtering on the received full-color environment image to obtain and output a corresponding filtered gradient image;
an on-site processing device, connected to the gradient filter and configured to perform histogram equalization on the received filtered gradient image to obtain and output a corresponding equalized image;
a signal enhancement device, connected to the on-site processing device and configured to perform image enhancement on the received equalized image by means of singular value decomposition (SVD), to obtain and output a corresponding signal-enhanced image;
a content storage mechanism, configured to store grayscale distribution ranges of pixel points of imaging regions of cartons having different humidities, the carton having a different humidity leading to a different grayscale distribution range of the pixel points of the imaging region of the carton;
a numerical analysis mechanism, connected to the signal enhancement device and the content storage mechanism and configured to: identify and partition a carton distribution region in the signal-enhanced image to obtain a carton sub-image, acquire grayscale values of pixel points in the carton sub-image, and acquire a median of the grayscale values to obtain a corresponding grayscale median; and
a range identification device, connected to the numerical analysis mechanism and the content storage mechanism and configured to determine, based on a grayscale distribution range in which the grayscale median falls, a humidity corresponding to the grayscale distribution range and output the humidity as an overall humidity of the carton.

2. The overall humidity analysis system for a carton according to claim 1, wherein
in the content storage mechanism, a higher humidity of the carton leads to a smaller value of the grayscale distribution range of the pixel points of the imaging region.

3. The overall humidity analysis system for a carton according to claim 2, wherein
in the content storage mechanism, the grayscale distribution ranges of the pixel points of the imaging regions of the cartons having the different humidities are all defined by an upper grayscale threshold and a lower grayscale threshold.

4. The overall humidity analysis system for a carton according to claim 3, wherein
the upper grayscale threshold is greater than the lower grayscale threshold, and values of the upper grayscale threshold and the lower grayscale threshold both range from 0 to 255; and
the numerical analysis mechanism, the signal enhancement device, and the content storage mechanism share one parallel configuration interface.

5. The overall humidity analysis system for a carton according to claim 4, further comprising:
a display device, connected to the numerical analysis mechanism and the range identification device, wherein
the display device is configured to display various working parameters of the numerical analysis mechanism and various working parameters of the range identification device.

6. The overall humidity analysis system for a carton according to claim 5, wherein
the display device is a liquid crystal display or a light-emitting diode (LED) display.

7. The overall humidity analysis system for a carton according to claim 6, further comprising:
a touch screen, configured to receive input information of a user according to an operation of the user, wherein
the display device, the numerical analysis mechanism, the range identification device, and the touch screen are integrated on an integrated circuit board.

8. The overall humidity analysis system for a carton according to claim 7, further comprising:
a video communication device, configured to wirelessly send an on-site image obtained by performing image capture on an environment where the numerical analysis mechanism is located.

9. The overall humidity analysis system for a carton according to claim 8, wherein
the video communication device comprises a compression encoder configured to perform MPEG-4 standard compression on the on-site image to obtain a compressed image; and
the video communication device further comprises a multi-index encoder connected to the compression encoder and configured to perform multi-index coding on the compressed image to obtain channel coded data.

10. The overall humidity analysis system for a carton according to claim 9, wherein
the video communication device comprises a wireless communication interface connected to the multi-index encoder and configured to wirelessly send the channel coded data, wherein
the wireless communication interface is a time division duplex (TDD) communication interface, a frequency division duplex (FDD) communication interface, a 4G communication interface, or a GPRS communication interface.
